(19) United States
(12) Patent Application Publication
(10) Pub. No.: US 2012/0262308 A1
(43) Pub. Date: Oct. 18, 2012

(54) SYSTEMS AND METHODS FOR PREVENTING CARGO GOODS FROM BEING STOLEN

(76) Inventor: TAI CHEUNG POON, Hong Kong (HK)

(21) Appl. No.: 13/088,372

(22) Filed: Apr. 17, 2011

(51) Int. Cl. G08B 23/00

(52) U.S. Cl. 340/984

(57) ABSTRACT

Systems and Methods for preventing cargo goods from stolen are provided. In one embodiment, a cargo alert system for preventing cargo goods from stolen is provided. In the embodiment, a GPS receiver attached on a vessel, wherein the GPS receiver receives GPS signals in an exposed, open area. Further, the embodiment includes a plurality of GPS receivers inside a cargo contained inside the vessel. The cargo contains a number of sliding doors to facilitate GPS reception. Further, the embodiment is configured to record information to keep track the cargo and the goods within the cargo.

### FIELD OF THE INVENTION

The invention generally relates to systems and methods for preventing cargo goods from stolen. Specifically, but without limitation, this invention relates to ascertaining the presence of cargo goods during navigation of a ship.

### BACKGROUND OF THE INVENTION

Cargo ships carry goods from one destination to another via the sea. These goods are contained in different cargo containers stacked on top from one another. The ships are under contracts to ascertain the delivery of the goods. The contracts may provide the quality of service guaranteed by the carrier owner and the shipper. In some contracts, the shipper requires the carrier to pay extra attention in making sure the goods to be delivered on time. Also, the shipper may ask the carrier to pay attention in terms of the safety of the goods in the delivery. The shipper may concern their goods being damaged. Therefore, many shippers may be required to purchase insurance to cover any losses that may be incurred in the shipping process.

Shippers may also concern the thefts that may occur when the goods are on aboard to the ship. In some expensive or delicate items, the shipper may not even want someone to touch or even move them, as some items, such as products containing confidential material, would have lost their values when they are disclosed to the public. Thus, shippers have always been looking for ways to know if their products are safe throughout the entire trip. However, the difficult part is that goods are always locked in cargo containers and stacked up from one against another. GPS technologies, would therefore, have its limitations to locate the containers and goods inside. As a result, there is a demand to resolve the GPS signal degradation used in the cargo container industry.

### SUMMARY OF THE INVENTION

A cargo alert system is provided for preventing cargo goods from stolen. According to an embodiment of the invention, a system is provided, comprising a GPS receiver attached on a vessel, wherein the GPS receiver receives GPS signals in an exposed, open area; a GPS receiver attached to a box of goods stored in a cargo placed inside the vessel.

Consistent with the embodiment, a first sliding door on a first side of the cargo is included. The first sliding door may be configured to be open, upon request by GPS receivers; a second sliding door on a second side of the cargo, wherein the second sliding door is configured to be open, only when the requesting GPS receivers fail to receive GPS signals after the first sliding door has been open; a third sliding door on a third side of the cargo.

Also, the third sliding door may be configured to be open, only when the requesting GPS receiver fail to receive GPS signals after the first and sliding doors have been open; a GPS receiver attached to a corner inside the cargo, wherein the corner joins the first, second, and third sliding door; a gyroscope attached to the box of goods stored in the cargo.

In one aspect of the invention, the gyroscope may be configured to determine if the box of goods has been moved by somebody by detecting whether a change of orientation of the box of goods has occurred, and when the box of goods is determined that it has been moved, the gyroscope containing a processor to notify the GPS attached to the box of goods stored in the cargo to record a position and a time into a memory contained in the gyroscope, wherein the position and the time refers to where and when the box of goods is moved; wherein during the recording of the position, the first sliding door, the second sliding door, and the third sliding door are used as windows for the GPS receiver attached to the box of goods stored in the cargo to receive a signal; a processor; a memory storing instructions that cause the processor to execute a method.

The method may comprise initiating the cargo alert system; periodically reporting the location of goods and cargo; reporting the location of goods and cargo, when the vessel has reached to a set of predetermined locations; reporting the location of goods and cargo, when the vessel stops; and reporting the location of goods and cargo, when the goods are found to be moved by someone.

### BRIEF DESCRIPTION OF THE DRAWINGS

FIG. 1 illustrates an exemplary system to prevent cargo goods from stolen.

### DETAILED DESCRIPTION

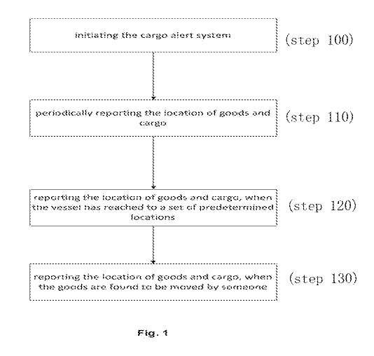

Systems and methods are provided to enhance performance of windmills. Referring to FIG. 1, one embodiment of the inventions include a cargo alert system for preventing cargo goods from stolen, comprising a GPS receiver attached on a vessel, wherein the GPS receiver receives GPS signals in an exposed, open area; a GPS receiver attached to a box of goods stored in a cargo placed inside the vessel; a first sliding door on a first side of the cargo, wherein the first sliding door is configured to be open, upon request by GPS receivers; a second sliding door on a second side of the cargo, wherein the second sliding door is configured to be open, only when the requesting GPS receivers fail to receive GPS signals after the first sliding door has been open; a third sliding door on a third side of the cargo, wherein the third sliding door is configured to be open, only when the requesting GPS receiver fail to receive GPS signals after the first and sliding doors have been open; a GPS receiver attached to a corner inside the cargo, wherein the corner joins the first, second, and third sliding door; a gyroscope attached to the box of goods stored in the cargo, wherein the gyroscope is configured to determine if the box of goods has been moved by somebody by detecting whether a change of orientation of the box of goods has occurred (130), and when the box of goods is determined that it has been moved, the gyroscope containing a processor to notify the GPS attached to the box of goods stored in the cargo to record a position and a time into a memory contained in the gyroscope, wherein the position and the time refers to where and when the box of goods is moved; wherein during the recording of the position, the first sliding door, the second sliding door, and the third sliding door are used as windows for the GPS receiver attached to the box of goods stored in the cargo to receive a signal; a processor; a memory storing instructions that cause the processor to execute a method, the method comprises initiating the cargo alert system (100); periodically reporting the location of goods and cargo (110); reporting the location of goods and cargo, when the vessel has reached to a set of predetermined locations (120); reporting the location of goods and cargo, when the vessel stops; and reporting the location of goods and cargo, when the goods are found to be moved by someone.

In another implemenation, a cargo alert system for preventing cargo goods from stolen, comprising a GPS receiver attached on a vessel, wherein the GPS receiver receives GPS signals in an exposed, open area; a GPS receiver attached to a box of goods stored in a cargo placed inside the vessel; a first sliding door on a first side of the cargo, wherein the first sliding door is configured to be open, upon request by GPS receivers; a second sliding door on a second side of the cargo, wherein the second sliding door is configured to be open, only when the requesting GPS receivers fail to receive GPS signals after the first sliding door has been open; a third sliding door on a third side of the cargo, wherein the third sliding door is configured to be open, only when the requesting GPS receiver fail to receive GPS signals after the first and sliding doors have been open; a GPS receiver attached to a corner inside the cargo, wherein the corner joins the first, second, and third sliding doors; a gyroscope attached to the box of goods stored in the cargo, wherein the gyroscope is configured to determine if the box of goods has been moved by somebody by detecting whether a change of orientation of the box of goods has occurred (130), and when the box of goods is determined that it has been moved, the gyroscope containing a processor to notify the GPS attached to the box of goods stored in the cargo to record a position and a time into a memory contained in the gyroscope, wherein the position and the time refers to where and when the box of goods is moved; wherein during the recording of the position, the first sliding door, the second sliding door, and the third sliding door are used as windows for the GPS receiver attached to the box of goods stored in the cargo to receive a signal; a processor; a memory storing instructions that cause the processor to execute a method, the method comprising initiating the cargo alert system (100), wherein the initiation includes reporting a GPS position of the goods, as measured by the GPS receiver attached to the box of goods stored in the cargo, through the first, second, or third sliding doors; reporting a GPS position of the cargo, as measured by the GPS receiver attached to the corner inside the cargo, through the first, second, or third sliding doors; closing the first, second, and third sliding doors; and notifying the vessel to start sailing; periodically reporting the location of goods and cargo (110); reporting the location of goods and cargo, when the vessel has reached to a set of predetermined locations (120); reporting the location of goods and cargo, when the vessel stops; and reporting the location of goods and cargo, when the goods are found to be moved by someone.

The cargo alert system can be implemented by using a GPS receiver attached on a vessel, wherein the GPS receiver receives GPS signals in an exposed, open area; a GPS receiver attached to a box of goods stored in a cargo placed inside the vessel; a first sliding door on a first side of the cargo, wherein the first sliding door is configured to be open, upon request by GPS receivers; a second sliding door on a second side of the cargo, wherein the second sliding door is configured to be open, only when the requesting GPS receivers fail to receive GPS signals after the first sliding door has been open; a third sliding door on a third side of the cargo, wherein the third sliding door is configured to be open, only when the requesting GPS receiver fail to receive GPS signals after the first and sliding doors have been open; a GPS receiver attached to a corner inside the cargo, wherein the corner joins the first, second, and third sliding doors; a gyroscope attached to the box of goods stored in the cargo, wherein the gyroscope is configured to determine if the box of goods has been moved by somebody by detecting whether a change of orientation of the box of goods has occurred (130), and when the box of goods is determined that it has been moved, the gyroscope containing a processor to notify the GPS attached to the box of goods stored in the cargo to record a position and a time into a memory contained in the gyroscope, wherein the position and the time refers to where and when the box of goods is moved; wherein during the recording of the position, the first sliding door, the second sliding door, and the third sliding door are used as windows for the GPS receiver attached to the box of goods stored in the cargo to receive a signal; a processor; a memory storing instructions that cause the processor to execute a method, the method comprising initiating the cargo alert system (100), wherein the initiation includes reporting a GPS position of the goods, as measured by the GPS receiver attached to the box of goods stored in the cargo, through the first, second, or third sliding doors; reporting a GPS position of the cargo, as measured by the GPS receiver attached to the corner inside the cargo, through the first, second, or third sliding doors; closing the first, second, and third sliding doors; notifying the vessel to start sailing; periodically reporting the location of goods and cargo (110), wherein the reporting is performed by the GPS receiver attached to the corner inside the cargo and the GPS receiver attached to the box of goods stored in the cargo respectively, through the first, second, or third sliding doors; reporting the location of goods and cargo, when the vessel has reached to a set of predetermined locations (120); reporting the location of goods and cargo, when the vessel stops; and reporting the location of goods and cargo, when the goods are found to be moved by someone.

In an example, the cargo alert system may include a GPS receiver attached on a vessel, wherein the GPS receiver receives GPS signals in an exposed, open area; a GPS receiver attached to a box of goods stored in a cargo placed inside the vessel; a first sliding door on a first side of the cargo, wherein the first sliding door is configured to be open, upon request by GPS receivers; a second sliding door on a second side of the cargo, wherein the second sliding door is configured to be open, only when the requesting GPS receivers fail to receive GPS signals after the first sliding door has been open; a third sliding door on a third side of the cargo, wherein the third sliding door is configured to be open, only when the requesting GPS receiver fail to receive GPS signals after the first and sliding doors have been open; a GPS receiver attached to a corner inside the cargo, wherein the corner joins the first, second, and third sliding doors; a gyroscope attached to the box of goods stored in the cargo, wherein the gyroscope is configured to determine if the box of goods has been moved by somebody by detecting whether a change of orientation of the box of goods has occurred (130), and when the box of goods is determined that it has been moved, the gyroscope containing a processor to notify the GPS attached to the box of goods stored in the cargo to record a position and a time into a memory contained in the gyroscope, wherein the position and the time refers to where and when the box of goods is moved; wherein during the recording of the position, the first sliding door, the second sliding door, and the third sliding door are used as windows for the GPS receiver attached to the box of goods stored in the cargo to receive a signal; a processor; a memory storing instructions that cause the processor to execute a method, the method comprises initiating the cargo alert system (100), wherein the initiation includes reporting a GPS position of the goods, as measured by the GPS receiver attached to the box of goods stored in the cargo, through the first, second, or third sliding doors; reporting a GPS position of the cargo, as measured by the GPS receiver attached to the corner inside the cargo, through the first, second, or third sliding doors; closing the first, second, and third sliding doors; notifying the vessel to start sailing; periodically reporting the location of goods and cargo (110), wherein the reporting is performed by the GPS receiver attached to the corner inside the cargo and the GPS receiver attached to the box of goods stored in the cargo respectively, through the first, second, or third sliding doors; reporting the location of goods and cargo, when the vessel has reached to a set of predetermined locations (120), using the GPS receiver attached on the vessel, the GPS receiver attached to the corner inside the cargo, and the GPS receiver attached to the box of goods stored in the cargo; reporting the location of goods and cargo, when the vessel stops; and reporting the location of goods and cargo, when the goods are found to be moved by someone.

The sliding doors may be equipped with additional functionalities. For example, a first sliding door may be installed on a first side of the cargo, wherein the first sliding door is configured to be open, upon request by GPS receivers; a second sliding door on a second side of the cargo, wherein the second sliding door is configured to be open, only when the requesting GPS receivers fail to receive GPS signals after the first sliding door has been open; a third sliding door on a third side of the cargo, wherein the third sliding door is configured to be open, only when the requesting GPS receiver fail to receive GPS signals after the first and sliding doors have been open; a GPS receiver attached to a corner inside the cargo, wherein the corner joins the first, second, and third sliding doors; a gyroscope attached to the box of goods stored in the cargo, wherein the gyroscope is configured to determine if the box of goods has been in the cargo; reporting the location of goods and cargo, when the vessel stops, using the GPS receiver attached to the corner inside the cargo and the GPS receiver attached to the box of goods stored in the cargo; and reporting the location of goods and cargo, when the goods are found to be moved by someone.

Alternatively, the first sliding door may be installed on a first side of the cargo, wherein the first sliding door is configured to be open, upon request by GPS receivers; a second sliding door on a second side of the cargo, wherein the second sliding door is configured to be open, only when the requesting GPS receivers fail to receive GPS signals after the first sliding door has been open; a third sliding door on a third side of the cargo, wherein the third sliding door is configured to be open, only when the requesting GPS receiver fail to receive GPS signals after the first and sliding doors have been open; a GPS receiver attached to a corner inside the cargo, wherein the corner joins the first, second, and third sliding doors; a gyroscope attached to the box of goods stored in the cargo, wherein the gyroscope is configured to determine if the box of goods has been moved by somebody by detecting whether a change of orientation of the box of goods has occurred (130), and when the box of goods is determined that it has been moved, the gyroscope containing a processor to notify the GPS attached to the box of goods stored in the cargo to record a position and a time into a memory contained in the gyroscope, wherein the position and the time refers to where and when the box of goods is moved; wherein during the recording of the position, the first sliding door, the second sliding door, and the third sliding door are used as windows for the GPS receiver attached to the box of goods stored in the cargo to receive a signal; a processor; a memory storing instructions that cause the processor to execute a method, the method comprising initiating the cargo alert system (100), wherein the initiation includes reporting a GPS position of the goods, as measured by the GPS receiver attached to the box of goods stored in the cargo, through the first, second, or third sliding doors; reporting a GPS position of the cargo, as measured by the GPS receiver attached to the corner inside the cargo, through the first, second, or third sliding doors; closing the first, second, and third sliding doors; notifying the vessel to start sailing; periodically reporting the location of goods and cargo (110), wherein the reporting is performed by the GPS receiver attached to the corner inside the cargo and the GPS receiver attached to the box of goods stored in the cargo respectively, through the first, second, or third sliding doors; reporting the location of goods and cargo, when the vessel has reached to a set of predetermined locations (120), using the GPS receiver attached on the vessel, the GPS receiver attached to the corner inside the cargo, and the GPS receiver attached to the box of goods stored in the cargo; reporting the location of goods and cargo, when the vessel stops, using the GPS receiver attached to the corner inside the cargo and the GPS receiver attached to the box of goods stored in the cargo; and reporting the location of goods and cargo, when the goods are found to be moved by someone, in accordance with the gyroscope attached to the box of goods stored in the cargo.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A cargo alert system for preventing cargo goods from stolen, comprising:
a GPS receiver attached on a vessel, wherein the GPS receiver receives GPS signals in an exposed, open area;
a GPS receiver attached to a box of goods stored in a cargo placed inside the vessel;
a first sliding door on a first side of the cargo, wherein the first sliding door is configured to be open, upon request by GPS receivers;
a second sliding door on a second side of the cargo, wherein the second sliding door is configured to be open, only when the requesting GPS receivers fail to receive GPS signals after the first sliding door has been open;
a third sliding door on a third side of the cargo, wherein the third sliding door is configured to be open, only when the requesting GPS receiver fail to receive GPS signals after the first and sliding doors have been open;
a GPS receiver attached to a corner inside the cargo, wherein the corner joins the first, second, and third sliding door;
a gyroscope attached to the box of goods stored in the cargo, wherein the gyroscope is configured to determine if the box of goods has been moved by somebody by detecting whether a change of orientation of the box of goods has occurred, and when the box of goods is determined that it has been moved, the gyroscope containing a processor to notify the GPS attached to the box of goods stored in the cargo to record a position and a time into a memory contained in the gyroscope, wherein the position and the time refers to where and when the box of goods is moved; wherein during the recording of the position, the first sliding door, the second sliding door, and the third sliding door are used as windows for the GPS receiver attached to the box of goods stored in the cargo to receive a signal;
a processor;
a memory storing instructions that cause the processor to execute a method, the method comprising:
initiating the cargo alert system;
periodically reporting the location of goods and cargo;
reporting the location of goods and cargo, when the vessel has reached to a set of predetermined locations;
reporting the location of goods and cargo, when the vessel stops; and
reporting the location of goods and cargo, when the goods are found to be moved by someone.

2. The system of claim 1, wherein during the initiating of the cargo alert system, the method further comprises:
reporting a GPS position of the goods, as measured by the GPS receiver attached to the box of goods stored in the cargo, through the first, second, or third sliding doors;
reporting a GPS position of the cargo, as measured by the GPS receiver attached to the corner inside the cargo, through the first, second, or third sliding doors;
closing the first, second, and third sliding doors; and
notifying the vessel to start sailing.

3. The system of claim 2, wherein during the periodically reporting of the location of goods and cargo, the reporting is performed by the GPS receiver attached to the corner inside the cargo and the GPS receiver attached to the box of goods stored in the cargo respectively, through the first, second, or third sliding doors.

4. The system of claim 3, wherein the reporting of the location of goods and cargo uses the GPS receiver attached on the vessel, the GPS receiver attached to the corner inside the cargo, and the GPS receiver attached to the box of goods stored in the cargo.

5. The system of claim 4, wherein the reporting of the location of goods and cargo uses the GPS receiver attached to the corner inside the cargo and the GPS receiver attached to the box of goods stored in the cargo.

6. The system of claim 5, wherein the reporting of the location of goods and cargo uses the gyroscope attached to the box of goods stored in the cargo.
